(19) United States
(12) Patent Application Publication
(10) Pub. No.: US 2015/0071273 A1
(43) Pub. Date: Mar. 12, 2015

(54) EFFICIENT TRANSFER OF TCP TRAFFIC OVER WLAN

(71) Applicant: CELENO COMMUNICATIONS (ISRAEL) LTD., Raanana (IL)

(72) Inventors: Oren Hencinski, Holon (IL); Boris Gimelbrand, Petah Tikva (IL)

(21) Appl. No.: 14/474,148

(22) Filed: Aug. 31, 2014

Related U.S. Application Data
(60) Provisional application No. 61/876,233, filed on Sep. 11, 2013.

(51) Int. Cl. H04L 1/08; H04W 80/06; H04W 84/12

(52) U.S. Cl. CPC H04L 1/08; H04W 84/12; H04W 80/06
USPC 370/338

(57) ABSTRACT

A method for communication includes receiving Transport Control Protocol (TCP) data packets from a first TCP endpoint, for forwarding over a Wireless Local-Area Network (WLAN) to a second TCP endpoint. The received TCP data packets are cached in a cache memory. The TCP data packets cached in the cache memory are forwarded over the WLAN to the second TCP endpoint, including retrying to forward one or more of the cached TCP data packets independently of the first TCP endpoint.

### CROSS-REFERENCE TO RELATED APPLICATIONS

This application claims the benefit of U.S. Provisional Patent Application 61/876,233, filed Sep. 11, 2013, whose disclosure is incorporated herein by reference.

### FIELD OF THE INVENTION

The present invention relates generally to wireless communication, and particularly to methods and systems for transferring Transmission Control Protocol (TCP) traffic over Wireless Local-Area Networks (WLAN).

### BACKGROUND OF THE INVENTION

A Wireless Local-Area Network (WLAN) typically comprises one or more Access Points (APs) that communicate with stations (STAs). WLAN communication protocols are specified, for example, in the IEEE 802.11 family of standards, such as in the 802.11n-2009 standard entitled “IEEE Standard for Information technology—Local and metropolitan area networks—Specific requirements—Part 11: Wireless LAN Medium Access Control (MAC) and Physical Layer (PHY) Specifications Amendment 5: Enhancements for Higher Throughput,” 2009; and in the 802.11ac-2013 standard entitled “IEEE Standard for Information technology—Local and metropolitan area networks—Specific requirements—Part 11: Wireless LAN Medium Access Control (MAC) and Physical Layer (PHY) Specifications Amendment 4: Enhancements for Very High Throughput for Operation in Bands below 6 GHz,” 2013, which are incorporated herein by reference. WLANs are also commonly referred to as Wi-Fi networks.

The Transmission Control Protocol (TCP) is a transport protocol that is used extensively over Internet Protocol (IP) networks. TCP is specified, for example, in various Requests For Comments (RFCs) of the Internet Engineering Task Force (IETF), such as RFC 675, entitled “Specification of Internet Transmission Control Program,” December, 1974; RFC 793, entitled “Transmission Control Protocol, DARPA Internet Program, Protocol Specification,” September, 1981; and RFC 5681, entitled “TCP Congestion Control,” September, 2009, which are incorporated herein by reference.

### SUMMARY OF THE INVENTION

An embodiment of the present invention that is described herein provides a method for communication including receiving Transport Control Protocol (TCP) data packets from a first TCP endpoint, for forwarding over a Wireless Local-Area Network (WLAN) to a second TCP endpoint. The received TCP data packets are cached in a cache memory. The TCP data packets cached in the cache memory are forwarded over the WLAN to the second TCP endpoint, including retrying to forward one or more of the cached TCP data packets independently of the first TCP endpoint.

In some embodiments, the method includes sending to the first TCP endpoint TCP acknowledgements for the received TCP data packets, irrespective of subsequent forwarding of the TCP data packets to the second TCP endpoint. In an embodiment, forwarding of the cached TCP data packets cached in the cache memory over the WLAN is performed irrespective of the TCP acknowledgements sent to the first TCP endpoint.

In another embodiment, retrying to forward the cached TCP data packets includes sending a retransmission of a given TCP data packet in response to failing to forward the given TCP data packet to the second endpoint. In a disclosed embodiment, the method includes deleting a given TCP data packet from the cache memory in response to successful forwarding of the given TCP data packet over the WLAN. In another embodiment, the method includes, in response to a failure in forwarding a given TCP data packet over the WLAN, forwarding over the WLAN a TCP retransmission of the given TCP data packet, while retaining the given TCP data packet in the cache memory.

There is additionally provided, in accordance with an embodiment of the present invention, a communication apparatus including a caching unit and a WLAN unit. The caching unit is configured to receive Transport Control Protocol (TCP) data packets from a first TCP endpoint, for forwarding over a WLAN to a second TCP endpoint, and to cache the received TCP data packets in a cache memory. The WLAN unit is configured to forward the TCP data packets cached in the cache memory of the caching unit over the WLAN to the second TCP endpoint, including retrying to forward one or more of the cached TCP data packets independently of the first TCP endpoint.

There is also provided, in accordance with an embodiment of the present invention, a method for communication including receiving an aggregated frame that includes multiple frames, in accordance with a Wireless Local-Area Network (WLAN) mode, which specifies that successfully-received frames are to be output in a same order as the order of the frames in the aggregated frame. In response to identifying that a given successfully-received frame in the aggregated frame carries a Transport Control Protocol Acknowledgement (TCP ACK), the TCP ACK is output regardless of the successful reception of previous frames in the aggregated frame.

In some embodiments, the frames include MAC Protocol Data Units (MPDUs), and the WLAN mode includes an MPDU aggregation (A-MPDU) mode. In an embodiment, the method includes identifying an additional TCP ACK in the previous frames in the aggregated frame, and discarding the additional TCP ACK.

There is further provided, in accordance with an embodiment of the present invention, a communication apparatus including a WLAN receiver and a WLAN unit. The WLAN receiver is configured to receive an aggregated frame that includes multiple frames, in accordance with a WLAN mode which specifies that successfully-received frames are to be output in a same order as the order of the frames in the aggregated frame. The WLAN unit is configured, in response to identifying that a given successfully-received frame in the aggregated frame carries a Transport Control Protocol Acknowledgement (TCP ACK), to output the TCP ACK regardless of the successful reception of previous frames in the aggregated frame.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a communication system that transmits TCP traffic over WLAN, in accordance with an embodiment of the present invention;

FIG. 2 is a flow chart that schematically illustrates a method for transmitting TCP traffic over WLAN, in accordance with an embodiment of the present invention; and

FIG. 3 is a message diagram that schematically illustrates low-latency processing of TCP acknowledgements, in accordance with an embodiment of the present invention.

### DETAILED DESCRIPTION OF EMBODIMENTS

### Overview

The TCP specifications define a number of adaptation mechanisms that aim to maintain reliability under varying link conditions. For example, TCP endpoints may adapt the link throughput and the TCP window size to match the quality of the link between them. TCP operation is typically conservative, in the sense that even a mild degradation in link quality may cause a radical reduction in throughput and TCP window size. Subsequent ramp-up of the throughput and window size is typically gradual and slow.

When TCP traffic is transferred over a WLAN, the interaction between the WLAN characteristics and the above-described TCP characteristics may be problematic. The WLAN inevitably increases the round-trip delay of the TCP connection, and may also increase the Packet Error Rate (PER). These two factors, unless accounted for, may cause the TCP endpoints to drop the throughput and window size considerably.

Moreover, the WLAN typically operates more efficiently in processing large aggregations of data, and less efficiently when processing small data chunks. This characteristic may lead to a negative feedback effect: The slow ramp-up in TCP throughput and window size causes additional degradation in WLAN efficiency, which further degrades the TCP link quality and causes a drop in throughput and window size, and so on. This avalanche process may lead to noticeable TCP drops or even TCP session time out.

Embodiments of the present invention that are described herein provide improved methods and systems for transferring TCP traffic over WLAN. In some embodiments, a WLAN device (e.g., a home gateway) receives TCP data packets from a first TCP endpoint (e.g., a TCP client) for forwarding over WLAN to a remote WLAN device and on to a second TCP endpoint (e.g., a TCP server).

In some embodiments, the WLAN device avoids the above-described negative-feedback effect by using an intermediate caching layer. In these embodiments, the WLAN device caches the TCP data packets received from to the first TCP endpoint. The WLAN device forwards cached TCP data packets from the caching layer over the WLAN to the second TCP endpoint, while retaining the cached copies of the packets. Forwarding over the WLAN is performed in accordance with the applicable WLAN protocol, including retries as needed.

Successfully-forwarded packets are deleted from the cache, and TCP retransmissions are sent from the caching layer to the second TCP endpoint for packets whose forwarding has failed. Retransmissions may be triggered, for example, by WLAN failure reports of the WLAN device, by retry requests from the second TCP endpoint, and/or by retry time-out (TCL RTO—occurring when the TCP ACK is not received on time).

In an example mode of operation, upon caching a TCP data packet received from the first TCP endpoint, the WLAN device immediately sends a TCP ACK back to the first TCP endpoint. This ACK is sent regardless of (and usually well before) the TCP data packet is delivered successfully to the second TCP endpoint. In this mode, the WLAN device typically discards TCP ACKs that arrive from the second TCP endpoint. In an alternative mode of operation, the WLAN device does not send TCP ACKs locally, but instead forwards to the first TCP endpoint TCP ACKs that arrive from the second TCP endpoint.

When using the first mode of operation (including locally-generated TCP ACKS), the first TCP endpoint (e.g., TCP client) receives TCP ACKs with small latency, regardless of the subsequent delay that will be introduced by the WLAN en-route to the second TCP endpoint (e.g., TCP server). In both modes, since TCP retries are handled by the caching layer, the first TCP endpoint does not need to perform TCP retries, and consequently perceives the TCP link as a high-quality link. The first TCP endpoint therefore operates with high throughput and large TCP window, regardless of the delay and possible PER that may occur downstream. Furthermore, since the first TCP endpoint operates with high throughput, the WLAN is provided with large uninterrupted aggregations of data, and is thus able to use the air interface efficiently and achieve high throughput.

Other embodiments that are described herein overcome performance degradation that occurs in WLAN frame aggregation modes such as MAC Protocol Data Unit Aggregation (A-MPDU) mode. In this mode, the transmit-side WLAN device aggregates multiple frames into a single aggregated frame. The receive-side WLAN device is required to output successfully-received frames to upper layers in the same order they were transmitted, i.e., in the same order as the order of the frames in the aggregated frame. Therefore, a successfully-received frame cannot be output until all previous frames in the aggregated frame are received successfully.

The above requirement is problematic when the aggregated frames carry TCP ACKs. For the TCP endpoint receiving the TCP ACKs, it is important to receive and act upon the latest TCP ACK, since it indicates the latest bytes that were received by the TCP server. When a given TCP ACK is available, previous TCP ACKs are obsolete. In other words, re-ordering of TCP ACKs is tolerable. In frame aggregation mode, however, maintaining frame order means that even if the frame carrying the latest TCP ACK is received successfully, the WLAN device is prevented from outputting it until all previous frames in the aggregated frame are received successfully. This constraint may cause unnecessary delays, possibly TCP drops, reduction in throughput and window size, and even session restart.

In some embodiments, the WLAN device avoids this delay by inspecting the frames (e.g., MPDUs) in the received aggregated frame (e.g., A-MPDU). If a certain successfully-received frame is found to carry a TCP ACK, the WLAN device outputs the TCP ACK regardless of successful or unsuccessful reception of previous frames in the aggregated frame. This deviation from the frame ordering requirement is permitted, since the frame content is known to be a TCP ACK, whose re-ordering is acceptable to the upper layers. As demonstrated hereinbelow, this technique enables considerable reduction in latency when transferring TCP ACKs over WLAN A-MPDUs.

### System Description

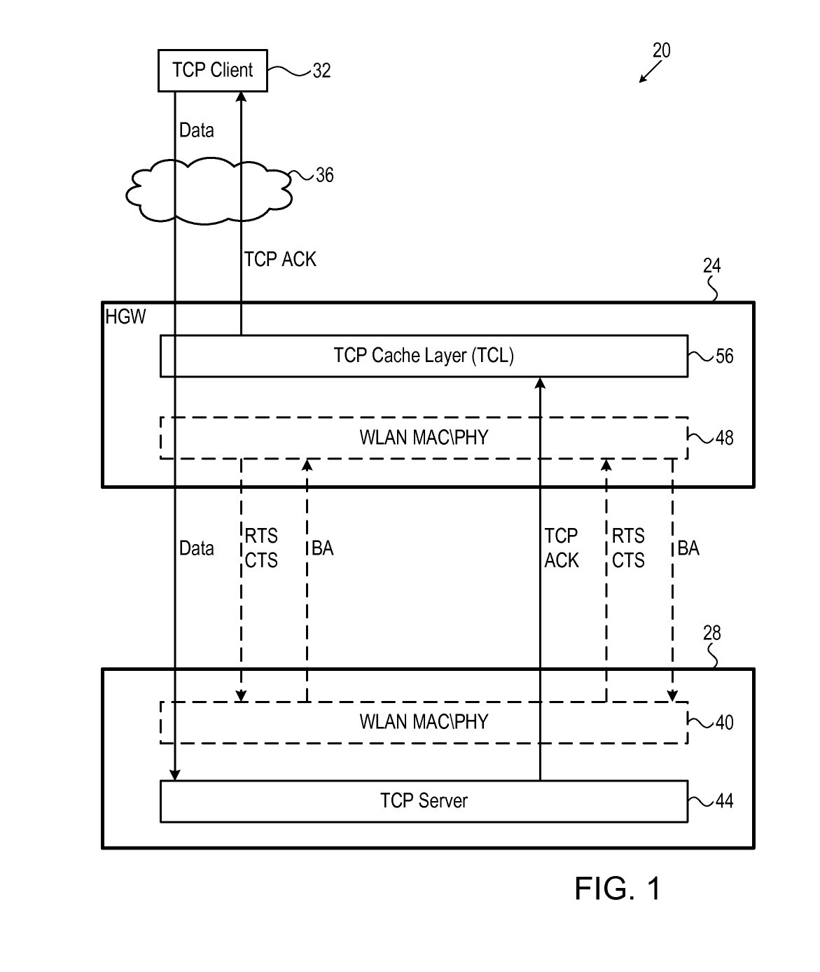

FIG. 1 is a block diagram that schematically illustrates a communication system 20 that transmits TCP traffic over WLAN, in accordance with an embodiment of the present invention. System 20 comprises a Home Gateway (HGW) 24 that provides WLAN communication services to one or more WLAN stations (STAs) 28.

From a WLAN standpoint the HGW plays the role of an Access Point (AP), and therefore the terms HGW and AP are used interchangeably herein. HGW 24 and STAs 28 may operate in accordance with any suitable WLAN standard or protocol, such as the IEEE 802.11n and 802.11ac specifications, cited above. The figure shows a single STA 28 for the sake of clarity. Real-life systems, however, typically comprise multiple STAs.

In the disclosed embodiments, STA 28 comprises a TCP server 44. HGW 24 is connected to a TCP client 32, e.g., via a network 36. The TCP client and TCP server communicate with one another by sending TCP data and control packets. HGW 24 and STA 28 transfer this TCP traffic over the WLAN air interface, using methods that are described in detail below.

In some embodiments, STA 28 comprises a WLAN unit 40 that carries out the various WLAN physical layer (PHY) and Medium Access Control (MAC) layer functions of the STA. HGW 24 comprises a WLAN unit 48 that carries out the various WLAN PHY and MAC layer functions of the HGW. Units 40 and 48 are also referred to herein as STA-WLAN and HGW-WLAN, respectively.

In some embodiments, HGW 24 comprises a TCP Cache Layer (TCL) 56, also referred to as a caching unit. Among other tasks, TCL 56 caches TCP data packets arriving from TCP client 32 in a cache memory, and transfers them efficiently to TCP server 44 over the WLAN. The functionality of TCL 56 is described in detail below. The HGW typically also comprises a WLAN transmitter and a WLAN receiver (not shown in the figures) for transmitting and receiving WLAN signals to and from STA 28.

The configurations of system 20, HGW 24 and STA 28 shown in FIG. 1 are example configurations, which are chosen purely for the sake of conceptual clarity. In alternative embodiments, any other suitable system, HGW (AP) and/or STA configuration can be used.

For example, the embodiments described herein refer mainly to TCP data packets sent from a TCP client to a TCP server. The disclosed techniques, however, can be used in a similar manner for TCP data packets sent from a TCP server to a TCP client (i.e., a TCP server connected to HGW 24 and a TCP client in STA 28). The TCL functionality may be implemented on the WLAN client side, e.g., in STA 28. The TCP server and TCP client are thus referred to collectively as TCP endpoints or TCP devices. As another example, the disclosed techniques are not limited to use in home gateways, and can be used generally in WLAN APs, as well as in any other suitable WLAN device.

The different elements of HGW 24 may be implemented using suitable hardware, such as in an Application-Specific Integrated Circuit (ASIC) or Field-Programmable Gate Array (FPGA). In some embodiments, some HGW and STA elements can be implemented using software, or using a combination of hardware and software elements. HGW and STA elements that are not mandatory for understanding of the disclosed techniques, have been omitted from the figure for the sake of clarity.

Certain elements of HGW 24 and/or STA 28 may be implemented using general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Efficient Transmission of TCP Traffic Over WLAN

As explained above, the interaction between WLAN and TCP characteristics may lead to a negative-feedback process that has a detrimental effect on the performance of a TCP connection transferred over WLAN. In some embodiments, HGW 24 avoids such scenarios by using TCL 56.

In some embodiments, HGW 24 breaks the end-to-end TCP connection between TCP client 32 and TCP server 44 into two parts, but without fully terminating the connection mid-way. The first part is between the TCP client and the HGW. The second part is between the HGW and the TCP server, including the WLAN channel.

Consider a flow of TCP data packets sent from TCP client 32 to TCP server 44. In some embodiments, TCL 56 in HGW 24 caches the incoming TCP data packets from TCP client 32 in memory. In an embodiment, upon caching, the TCL immediately acknowledges the TCP data packets by sending

TCP ACK packets to the TCP client. The TCL sends the TCP ACKs independently of subsequent forwarding of the TCP data packets to the TCP server. An alternative embodiment, in which the TCL does not send locally-generated TCP ACKs to the TCP client, is addressed further below.

In parallel to receiving, caching and acknowledging TCP data packets vis-à-vis TCP client 32, TCL 56 forwards the TCP data packets over the WLAN to TCP server 44, with high efficiency and reliability. Typically, TCL 56 forwards the TCP data packets to HGW-WLAN 48, while retaining the cached copies of the packets. HGW-WLAN 48 sends the TCP data packets to STA-WLAN 40 in accordance with the WLAN protocol, including retries as needed. The WLAN retries between the HGW-WLAN and STA-WLAN are typically performed independently of (and typically later than) the TCP ACKs sent for these TCP data packets to the TCP client.

Per aggregation, and after WLAN retries, HGW-WLAN 48 reports to TCL 56 which TCP data packets were forwarded successfully and which data packets need to be retransmitted. TCL 56 discards the successfully-forwarded packets from its cache memory, and sends TCP retransmissions for packets that were not forwarded successfully.

By using TCL 56 in this manner, HGW 24 decouples the WLAN operation from the TCP operation, and therefore avoids the negative-feedback scenario described above: TCP client 32 receives from TCL 56 TCP ACKs with small latency, regardless of the subsequent delay that will be introduced by the WLAN. Moreover, since TCP retries are handled by TCL 56, TCP client 32 does not need to perform TCP retries. As a result, the TCP client perceives the TCP link as a high-quality link, and therefore operates with high throughput and large TCP window. Furthermore, since the TCP client operates with high throughput, HGW-WLAN is provided with large uninterrupted aggregations of data. As a result, the HGW-WLAN is able to use the air interface efficiently and achieve high throughput.

In an alternative embodiment, TCL 56 does not send TCP ACKs to TCP client 32 upon caching TCP data packets. In this alternative embodiment, the TCP client is still decoupled from TCP packet loss events, because such events are handled independently by the TCL using the cached copies of the packets. TCP ACKs, however, are generated conventionally by the TCP server and forwarded to the TCP client by the TCL.

In summary, by employing TCL 56, HGW 56 turns the negative-feedback interaction between the TCP and WLAN into positive-feedback interaction. The end-to-end TCP-over-WLAN connection between TCP client 32 and TCP server 44 thus enjoys high stability, high throughput and high reliability.

The description above refers to a scenario that involves a single TCP client. The disclosed technique, however, can be applied in a similar manner in multi-client scenarios. When using the disclosed technique, the TCP stacks of the various TCP clients are able to ramp up quickly to high throughput and large TCP window size, and suffer less from starvation.

In some embodiments, the disclosed technique enables HGW-WLAN 48 to select data rates more aggressively, i.e., to try and select high-rate Modulation and Coding Schemes (MCS). In case of an over-aggressive MCS selection, the resulting high PER is resolved using WLAN retries between the HGW-WLAN and the STA-WLAN, without causing TCP drops or starvation to other TCP clients.

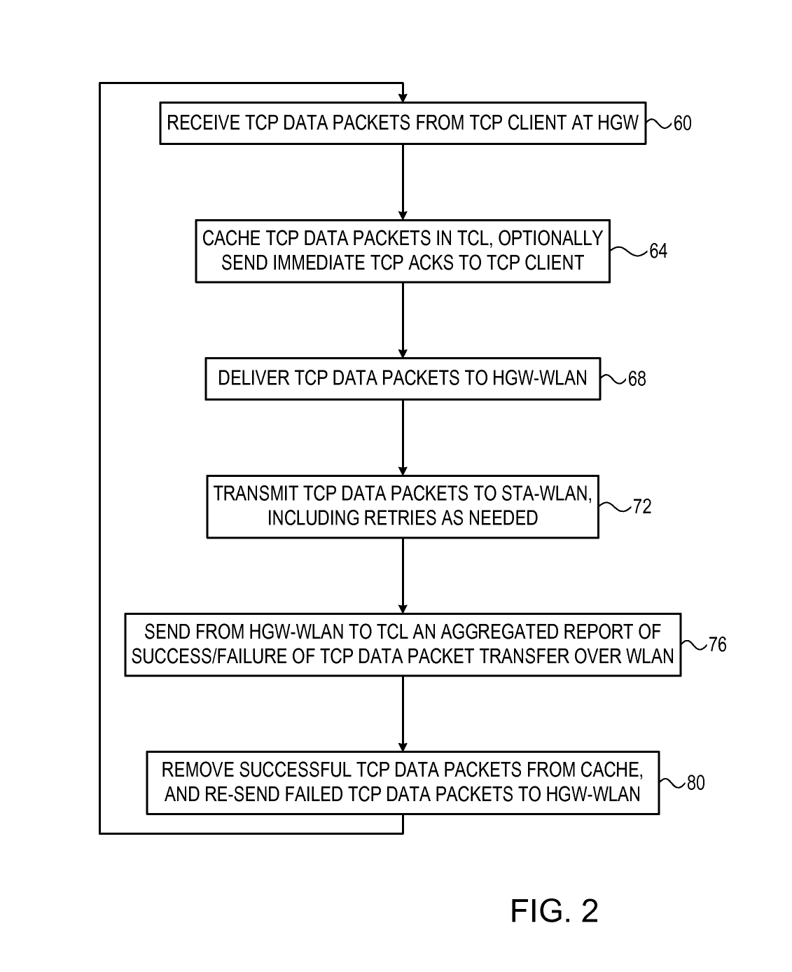

FIG. 2 is a flow chart that schematically illustrates a method for transmitting TCP traffic over WLAN, in accordance with an embodiment of the present invention. The method begins with HGW 24 receiving TCP data packets from TCP client 32, at a reception step 60. TCL 56 caches the received TCP data packets, at a caching step 64. Optionally, the TCL returns TCP ACKs to the TCP client upon caching the received TCP data packets.

Typically, TCL 56 assigns respective internal sequence numbers to the cached TCP data packets. This internal sequence numbering is distinct from and independent of TCP sequence numbering or any sequence numbering that may be used by the WLAN protocol. The internal sequence numbers issued by the TCL are later used for managing subsequent TCP retries.

TCL 56 forwards the TCP data packets to HGW-WLAN 48, at a forwarding step 68, while retaining the cached copies of the TCP data packets. HGW-WLAN 48 transmits the TCP data packets to STA-WLAN 40 over the WLAN channel, with retries as necessary, at a WLAN transmission step 72.

At a reporting step 76, HGW-WLAN 48 reports to TCL 56 which TCP data packets were forwarded successfully to STA-WLAN 40 and which were not. This report is typically aggregated, e.g., constructed and sent per aggregation of data packets. The report typically indicates the internal sequence numbers of the successful and failed TCP data packets.

In response to the report, TCL 56 selectively retransmits TCP data packets, at a selective TCP retransmission step 80. TCL 56 typically discards from its cache the TCP data packets that were forwarded successfully. The TCL retransmits (forwards to HGW-WLAN) TCP data packets whose forwarding has failed. This technique is considerably faster than the TCP selective ACK mechanism, and therefore reduces the retry latency considerably. The method then loops back to step 60 above.

In the description above, TCL 56 retransmits cached TCP data packets in response to an aggregated success/failure report from HGW-WLAN 48. Additionally or alternatively, the TCL may perform retries in response to other types of events, for example in response to a TCP retry request arriving from TCP server 44, in response to a time-out in waiting for a TCP ACK (TCL RTO), or any other suitable event.

### Low-Latency Processing of TCP Acknowledgements

The IEEE-802.11n and IEEE-802.11ac specifications define a mode of MAC Protocol Data Unit (MPDU) aggregation, also referred to as A-MPDU. In this mode, a transmit-side WLAN device (AP or STA) aggregates multiple frames and transmits them en-bloc as a single aggregated frame. The receive-side WLAN device returns a single Block Acknowledgement (BA) frame that indicates (using a bitmap) which of the multiple frames were received successfully and which have failed. In addition, the receive-side WLAN device is required to output successfully-received frames to upper layers in the same order they were transmitted, i.e., in the same order as the order of the frames in the aggregated frame.

The requirement to maintain frame order is problematic when the aggregated frames carry TCP ACKs. Consider HGW 24 and STA 28 of FIG. 1, when system 20 operates in the A-MPDU mode. In this mode, the traffic from TCP server 44 to TCP client 32 comprises TCP ACKs, usually intermixed with TCP data. For the TCP client it is important to receive and act upon the latest TCP ACK, since it indicates the latest bytes that were received by the TCP server. When a given TCP ACK is available, previous TCP ACKs are of no importance.

Maintaining frame order in A-MPDU means that, even if the frame carrying the latest TCP ACK is received successfully, the HGW-WLAN is prevented from outputting it to the TCP client until all previous frames in the aggregated frame are received successfully.

This constraint may cause unnecessary delays, possibly TCP drops, reduction in throughput and window size, and even session restart. The degradation is particularly noticeable in real-life scenarios in which PER on the WLAN channel is non-negligible, and in multi-client scenarios. All the above performance degradation, however, is unnecessary since previous TCP ACKs are obsolete and re-ordering of TCP ACKs is tolerable.

In some embodiments, HGW-WLAN 48 avoids this delay by inspecting the frames (MPDUs) in the received aggregated frame (A-MPDU). If a certain successfully-received frame is found to carry a TCP ACK, HGW-WLAN 48 forwards the TCP ACK to TCP client 32 immediately, regardless of frame order and regardless of successful reception of previous frames (MPDUs) in the aggregated frame (A-MPDU).

This deviation from the frame ordering requirement is permitted, since the frame content is known to be a TCP ACK, whose re-ordering is acceptable to the upper layers. For other frames in the aggregated frame, the HGW-WLAN retains the original frame order. In some embodiments, after outputting a given TCP ACK, the HGW-WLAN discards any previous TCP ACK that is received later due to frame re-ordering.

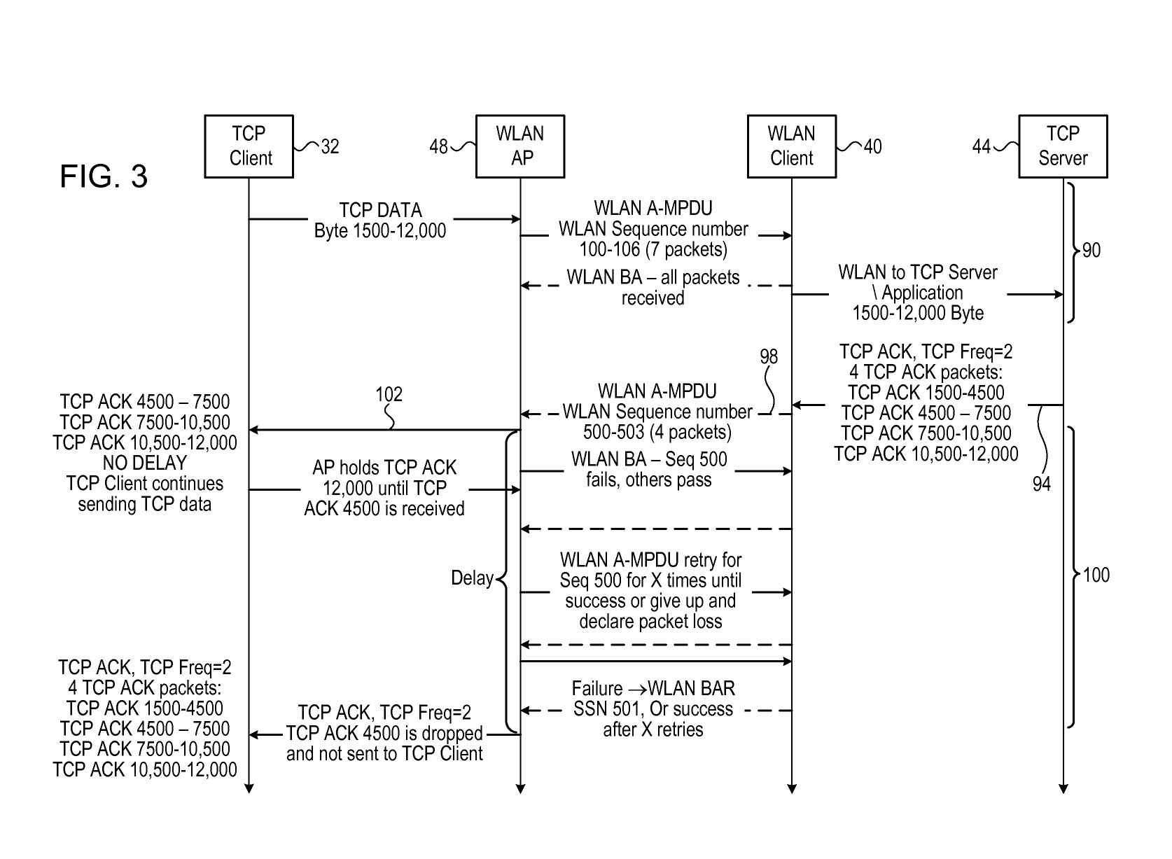

FIG. 3 is a message diagram that demonstrates the above-described low-latency processing of TCP ACKs in the A-MPDU mode, in accordance with an embodiment of the present invention. The figure shows example message flows between TCP client 32, HGW-WLAN 48 (denoted WLAN AP in this example), STA-WLAN 40 (denoted WLAN client in this example) and TCP server 44.

A message flow 90 demonstrates successful delivery of TCP data from the TCP client to the TCP server in the A-MPDU mode. The process begins with the TCP client sending bytes 1500-12000 to the WLAN AP. The WLAN AP formats the TCP data in seven WLAN frames (MPDUs) having sequence numbers 100-106, aggregates the MPDUs into a single aggregated frame (A-MPDU), and sends the A-MPDU to the WLAN client over the WLAN channel. (In the present context, the terms frames, packets and MPDUs are used interchangeably.) The WLAN client in this example receives all the frames of the aggregated frame successfully. Therefore, the WLAN client sends a Block Acknowledgement (BA) to the WLAN AP, with a bitmap indicating that all frames were received successfully. The WLAN client then outputs the TCP data (bytes 1500-12000) to the TCP server.

In response to the successful reception of the TCP data, the TCP server generates four TCP ACK packets (marked 94) and sends them to the WLAN client. Each TCP ACK packet indicates successful reception of a range of bytes, as shown in the figure. The WLAN client formats the four TCP ACKs in four respective WLAN frames (MPDUs) having sequence numbers 500-503, aggregates the four MPDUs into a single aggregated frame (A-MPDU), and sends the A-MPDU (marked 98) to the WLAN AP over the WLAN channel.

In this example, assume that the first frame in the aggregated frame (having sequence number 500, and carrying the TCP ACK that acknowledges bytes 1500-4500) has failed, and the other frames in the aggregated frame were received successfully.

The figure now shows two possible scenarios: A flow marked 100 shows the conventional scenario that retains frame ordering. A flow 102 (a single message in this case) shows the scenario of immediate delivery of frames carrying TCP ACKs, in accordance with an embodiment of the present invention.

In the conventional process (100), since the frame having sequence number 500 has failed, the WLAN AP does not deliver any of the three successfully-received TCP ACKs (in the frames having sequence numbers 501-503, acknowledging bytes 4500-7500, 7500-10500 and 10500-12000) to the TCP client, due to the frame order constraint. Instead, the WLAN AP sends a Block Acknowledgement (BA) to the WLAN client, with a bitmap indicating the sequence number 500 has failed and sequence numbers 501-503 were received successfully.

In response, the WLAN client retries to send the failed frame (sequence number 500) until successful reception or until giving-up after a certain number of attempts. Only at this stage, the WLAN AP outputs the TCP ACKs to the TCP client.

In the alternative scenario (102), in accordance with an embodiment of the present invention, the WLAN AP inspects each of the successfully-received frames in the aggregated frame. If a successfully-received frame is found to carry a TCP ACK, then the WLAN AP outputs the TCP ACK to the TCP client regardless of whether previous frames in the aggregated frame were received successfully or not.

In the present example, the WLAN AP fails to receive the first frame (sequence number 500) of the aggregated frame. Nevertheless, upon successfully receiving the next frame (sequence number 501), the WLAN AP finds that this frame carries a TCP ACK (the TCP ACK acknowledging bytes 4500-7500, which obsoletes the previous TCP ACK of bytes 1500-4500). The WLAN AP outputs this TCP ACK immediately to the TCP client, regardless of the fact that the previous frame was not received successfully. In a similar manner, the WLAN AP then outputs the successfully-received TCP ACKs for bytes 7500-10500 and 10500-12000.

As a result of the disclosed technique, the TCP client is free to continue sending TCP data at much earlier time than in the conventional process. The unnecessary delay save by the disclosed technique is marked at the bottom of the figure.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for communication, comprising:
receiving Transport Control Protocol (TCP) data packets from a first TCP endpoint, for forwarding over a Wireless Local-Area Network (WLAN) to a second TCP endpoint;
caching the received TCP data packets in a cache memory; and
forwarding the TCP data packets cached in the cache memory over the WLAN to the second TCP endpoint, including retrying to forward one or more of the cached TCP data packets independently of the first TCP endpoint.

2. The method according to claim 1, and comprising sending to the first TCP endpoint TCP acknowledgements for the received TCP data packets, irrespective of subsequent forwarding of the TCP data packets to the second TCP endpoint.

3. The method according to claim 2, wherein forwarding of the cached TCP data packets cached in the cache memory over the WLAN is performed irrespective of the TCP acknowledgements sent to the first TCP endpoint.

4. The method according to claim 1, wherein retrying to forward the cached TCP data packets comprises sending a retransmission of a given TCP data packet in response to failing to forward the given TCP data packet to the second endpoint.

5. The method according to claim 1, and comprising deleting a given TCP data packet from the cache memory in response to successful forwarding of the given TCP data packet over the WLAN.

6. The method according to claim 1, and comprising, in response to a failure in forwarding a given TCP data packet over the WLAN, forwarding over the WLAN a TCP retransmission of the given TCP data packet, while retaining the given TCP data packet in the cache memory.

7. A communication apparatus, comprising:
a caching unit, which is configured to receive Transport Control Protocol (TCP) data packets from a first TCP endpoint, for forwarding over a Wireless Local-Area Network (WLAN) to a second TCP endpoint, and to cache the received TCP data packets in a cache memory; and
a WLAN unit, which is configured to forward the TCP data packets cached in the cache memory of the caching unit over the WLAN to the second TCP endpoint, including retrying to forward one or more of the cached TCP data packets independently of the first TCP endpoint.

8. The apparatus according to claim 7, wherein the caching unit is configured to send to the first TCP endpoint TCP acknowledgements for the received TCP data packets, irrespective of subsequent forwarding of the TCP data packets to the second TCP endpoint.

9. The apparatus according to claim 8, wherein the WLAN unit is configured to forward the cached TCP data packets cached in the cache memory over the WLAN irrespective of the TCP acknowledgements sent to the first TCP endpoint.

10. The apparatus according to claim 7, wherein the WLAN unit is configured to retry to forward a given TCP data packet over the WLAN in response to failing to forward the given TCP data packet to the second endpoint.

11. The apparatus according to claim 7, wherein the caching unit is configured to delete a given TCP data packet from the cache memory in response to successful forwarding of the given TCP data packet over the WLAN.

12. The apparatus according to claim 7, wherein, in response to a failure in forwarding a given TCP data packet over the WLAN, the caching unit is configured to deliver to the WLAN unit a TCP retransmission of the given TCP data packet for forwarding over the WLAN, while retaining the given TCP data packet in the cache memory.

13. A method for communication, comprising:
receiving an aggregated frame that comprises multiple frames, in accordance with a Wireless Local-Area Network (WLAN) mode, which specifies that successfully-received frames are to be output in a same order as the order of the frames in the aggregated frame; and
in response to identifying that a given successfully-received frame in the aggregated frame carries a Transport Control Protocol Acknowledgement (TCP ACK), outputting the TCP ACK regardless of the successful reception of previous frames in the aggregated frame.

14. The method according to claim 13, wherein the frames comprise MAC Protocol Data Units (MPDUs), and wherein the WLAN mode comprises an MPDU aggregation (A-MPDU) mode.

15. The method according to claim 13, and comprising identifying an additional TCP ACK in the previous frames in the aggregated frame, and discarding the additional TCP ACK.

16. A communication apparatus, comprising:
a Wireless Local-Area Network (WLAN) receiver, which is configured to receive an aggregated frame that comprises multiple frames, in accordance with a WLAN mode which specifies that successfully-received frames are to be output in a same order as the order of the frames in the aggregated frame; and
a WLAN unit, which is configured, in response to identifying that a given successfully-received frame in the aggregated frame carries a Transport Control Protocol Acknowledgement (TCP ACK), to output the TCP ACK regardless of the successful reception of previous frames in the aggregated frame.

17. The apparatus according to claim 16, wherein the frames comprise MAC Protocol Data Units (MPDUs), and wherein the WLAN mode comprises an MPDU aggregation (A-MPDU) mode.

18. The apparatus according to claim 16, wherein the WLAN unit is configured to identify an additional TCP ACK in the previous frames in the aggregated frame, and to discard the additional TCP ACK.
